(19) United States
(12) Patent Application Publication
(10) Pub. No.: US 2025/0014553 A1
(43) Pub. Date: Jan. 9, 2025

(54) INPUT DEVICE

(71) Applicant: YAMAHA CORPORATION, Hamamatsu-shi (JP)

(72) Inventor: Yuji MIURA, Hamamatsu-shi (JP)

(21) Appl. No.: 18/895,755

(22) Filed: Sep. 25, 2024

Related U.S. Application Data
(63) Continuation of application No. PCT/JP2022/048238, filed on Dec. 27, 2022.

(30) Foreign Application Priority Data
Mar. 25, 2022 (JP) 2022-049446

(51) Int. Cl. G10H 1/34; G10H 1/00

(52) U.S. Cl. CPC G10H 1/34; G10H 1/0008; G10H 2220/221; G10H 2250/435

(57) ABSTRACT

An input device includes: a first region including one or more operators to which a bass drum tone is assigned; a second region including one or more operators to which a snare drum tone is assigned; and a third region including one or more operators to which a cymbal tone is assigned. The second region and the third region are arranged in order in a direction away from the first region, and a shape of the first region, a shape of the second region, and a shape of the third region are different from one another.

### CROSS-REFERENCE TO RELATED APPLICATIONS

This is a continuation of International Application No. PCT/JP2022/048238 filed on Dec. 27, 2022 and claims priority from Japanese Patent Application No. 2022-049446 filed on Mar. 25, 2022, the entire content of which is incorporated herein by reference.

### FIELD

The present disclosure relates to an input device.

### BACKGROUND

JP2018-072734A discloses an input device for inputting performance information, which allows a quick input operation using a natural hand form. In the input device, an input area group in which a plurality of operators (pads) are arranged in a substantial band shape has a shape bent to the left in a width direction as it advances from a first position to a second position. A sound parameter is assigned to each operator. A boundary line between the operators is a curved line which is convex in a direction toward an upper center. With such an arrangement, a user can place an index finger, a middle finger, and a ring finger on each operator in a natural form.

### SUMMARY

However, a frequency of use, a frequency of continuous striking, and the like vary depending on a tone assigned to an operator. In addition, there are tones to be emitted mutually exclusive, and there are tones to be emitted simultaneously. Therefore, it is desirable to consider the arrangement of the operators in consideration of an actual performance mode. In particular, if a posture of a hand and fingers is not natural, it is difficult to perform a fast or accurate operation, and the user is easily tired and a burden on the body increases. For example, depending on the operation requiring change of a distance between fingers or movement of an elbow, it is difficult to repeat the movement many times or to perform the movement quickly and accurately. Therefore, there is room for improvement in facilitating an input operation of performance information.

An object of the present disclosure is to provide an input device capable of facilitating an input operation of performance information.

According to an aspect of the present disclosure, there is provided an input device including: a first region including one or more operators to which a bass drum tone is assigned; a second region including one or more operators to which a snare drum tone is assigned; and a third region including one or more operators to which a cymbal tone is assigned, in which: the second region and the third region are arranged in order in a direction away from the first region; and a shape of the first region, a shape of the second region, and a shape of the third region are different from one another.

According to an aspect of the present disclosure, it is possible to facilitate an input operation of performance information.

### BRIEF DESCRIPTION OF DRAWINGS

The present disclosure will be described in detail based on the following without being limited thereto, wherein:

FIG. 1 is a plan view of an input device;

FIG. 2 is a plan view of a pad operation portion;

FIG. 3 is a diagram showing an example of a pad operation mode; and

FIG. 4 is an enlarged view of a plurality of pads in a pad operation portion according to a modification.

### DETAILED DESCRIPTION

Hereinafter, an embodiment of the present disclosure will be described with reference to the drawings.

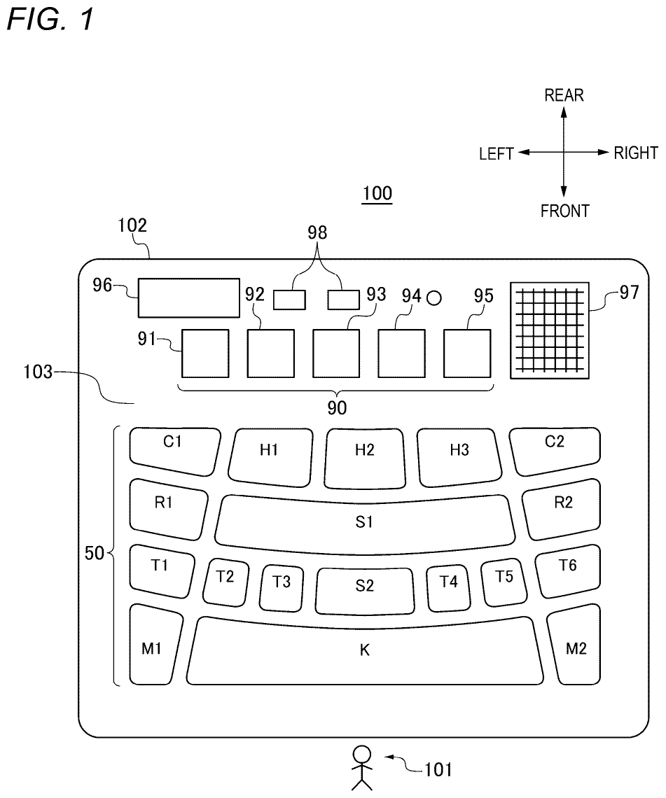

FIG. 1 is a plan view of an input device according to a first embodiment of the present disclosure. An input device 100 is an input device suitable for inputting a performance operation (performance information), and is implemented as an electronic musical instrument (electronic percussion instrument) as an example.

The input device 100 includes a housing 102. A panel 103 is provided on an upper surface of the housing 102. A pad operation portion 50, a setting operation portion 90, a display portion 96, and a speaker 97 are disposed on the panel 103. The setting operation portion 90 is an instruction reception portion including an operator that receives a sound parameter setting instruction from a user 101. The setting operation portion 90 includes a menu button 91, a linkage mode validation/invalidation button 92, a replacement mode validation/invalidation button 93, a replacement execution button 94, a determination button 95, and an increase and decrease buttons 98.

The pad operation portion 50 is an operation reception portion including a plurality of operators (hereinafter, referred to as pads) for the user 101 to input performance information. The plurality of pads included in the pad operation portion 50 include pads K, H1 to H3, C1, C2, S1, S2, R1, R2, M1, M2, and T1 to T6.

The user 101 usually uses the input device 100 at a position on a front side of the pad K, as shown in FIG. 1. Hereinafter, for the sake of convenience, the front side as viewed from the user 101 is defined as a front side, a back side is defined as a rear side, and a left-right direction is also based on the direction seen from the user 101.

Although each pad has a different shape, a basic configuration is common to one another. Each pad is a physical switch constituting an input area to be subjected to an input operation (performance operation). Each pad includes a surface sheet, a base plate (not shown), and a sensor (not shown). The base plate is, for example, a metal plate or a plastic plate. The sensor is disposed on the base plate, and the surface sheet is disposed thereon. The surface sheet constitutes a surface of the pad. The surface of the pad is flat and exposed from the panel 103. When performing the input operation, the user 101 may tap the pad with a finger. In order to alleviate an impact on the finger, for example, a rubber plate is employed as the surface sheet.

The sensor detects the input operation by the user 101. The sensor is provided for each pad. The sensor is, for example, a pressure sensor that detects a change in pressure applied to a corresponding pad. The sensor outputs a signal having an amplitude corresponding to a change in pressure as information indicating the input operation. The sensor is not limited to the pressure sensor, and may be a vibration sensor.

As an example, each pad is implemented as follows. A conductive pattern on a substrate, a conductive sheet, and a rubber sheet are disposed in order from the bottom. A spacer is provided under the conductive sheet, and even when the rubber sheet is placed on the conductive pattern, the conductive pattern and the conductive sheet are not electrically conductive, or are only slightly electrically conductive. When a pressure is applied from above by tapping (or pushing) the rubber sheet with a finger or the like, the conductive sheet is pushed and comes into contact with the conductive pattern, and a voltage value changes according to a contact area. When the sensor detects the voltage value, it is possible to detect a strength of tapping (or pushing) with a finger.

Each pad is assigned an electronic sound tone, such as a drum (which may also include percussion) tone. The tone of the electronic sound that can be assigned is not limited. When the user 101 performs the input operation on the pad, a sound of a tone corresponding to the pad is emitted from the speaker 97.

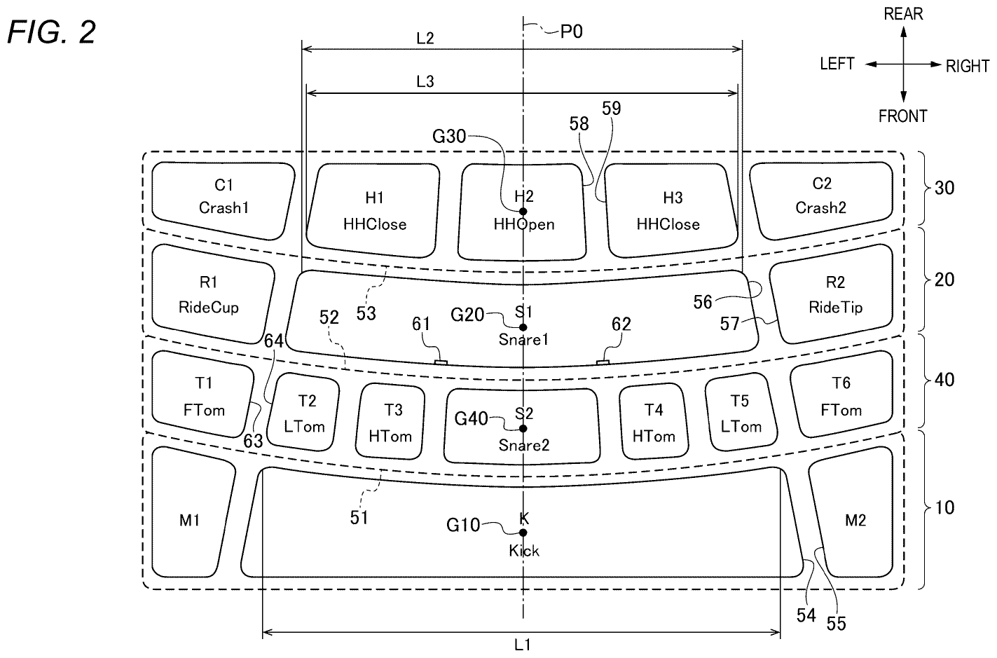

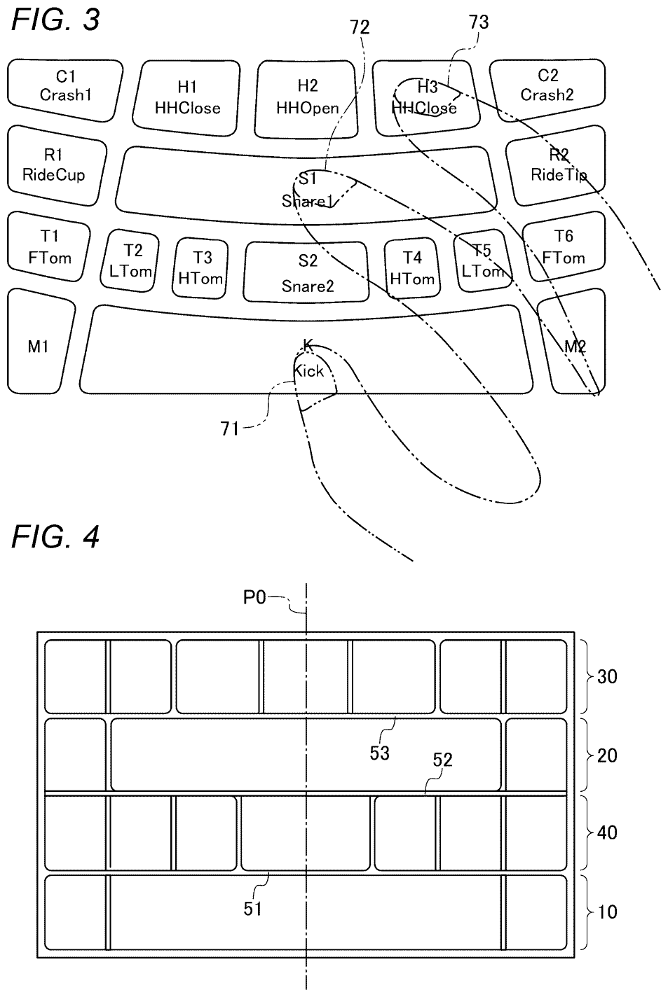

An arrangement of a plurality of pads will be described with reference to FIGS. 2 and 3. FIG. 2 is a plan view of the pad operation portion 50.

As shown in FIG. 2, the pad operation portion 50 includes a first region 10, a second region 20, a third region 30, and a fourth region 40. An arrangement direction of the first, second, third, and fourth regions is a front-rear direction. A direction perpendicular to the arrangement direction is a left-right direction. The first region 10, the fourth region 40, the second region 20, and the third region 30 are disposed in this order in a direction away from the first region 10 (rearward). The fourth region 40 is between the first region 10 and the third region 30. Shapes of the first region 10, the second region 20, and the third region 30 are different from one another. The first region 10 and the second region 20 are adjacent to each other in the front-rear direction.

The first region 10 includes one or more pads to which a bass drum tone is assigned, and includes pads K, M1, and M2 as an example. The second region 20 includes one or more pads to which a snare drum tone is assigned, and includes pads S1, R1, and R2 as an example. The third region 30 includes one or more pads to which a cymbal tone is assigned, and includes pads H1 to H3, C1, and C2 as an example. The fourth region 40 includes one or more pads to which a tom drum tone is assigned, and includes pads S2 and T1 to T6 as an example.

The following tones are assigned to the respective pads. A kick drum (Kick) tone (also referred to as a bass drum) is assigned to the pad K. A first snare drum tone and a second snare drum tone are assigned to the pads S1 and S2, respectively. The same floor tom drum tone is assigned to the pads T1 and T6, the same low tom drum tone is assigned to the pads T2 and T4, and the same high tom drum tone is assigned to the pads T3 and T4.

A first ride cymbal (RideCup) tone (for example, a sound of striking the cup) and a second ride cymbal (RideTip) tone (for example, a sound of striking a bow with a tip of a stick) are assigned to the pads R1 and R2, respectively. An open hi-hat cymbal tone is assigned to the pad H2, and the same closed hi-hat cymbal tone is assigned to the pads H1 and H3. A first crash cymbal tone and a second crash cymbal tone are assigned to the pads C1 and C2, respectively.

Other tones with a low performance frequency are assigned to the pads M1 and M2, respectively. Examples of other tones include tones such as a closed rim shot, another kick drum, another snare drum, another tom drum, special cymbals (China cymbal, splash cymbal), and percussion. Any tone may be assigned to each pad. In particular, by assigning any tone desired by the user 101 to the pads M1 and M2, the performance expression is widened.

The input device 100 has a so-called finger drum shape. As described below, the embodiment aims to implement a pad layout suitable for human hand characteristics and drum performance characteristics. For example, typical performance (beats, fill-ins) can be achieved in a natural hand shape without a burden of movement, making it less tiring even when the performance is performed for a long time.

The centroids of the pads K, S2, S1, and H2 are defined as G10, G40, G20, and G30, respectively. When viewed from above, a virtual straight line passing through G10, G40, G20, and G30 is defined as P0. The virtual straight line P0 is also a center line of the pad operation portion 50 extending in the left-right direction. The virtual straight line P0 is also a center line of each of the first region 10, the second region 20, the third region 30, and the fourth region 40 in the left-right direction. The input device 100 is assumed to be operated by either a right-handed dominant hand or a left-handed dominant hand, and is also assumed to be operated by both hands. Therefore, the entire pad is laid out line-symmetrically with respect to the virtual straight line P0 in the left-right direction.

First, the pads K, S2, S1, and H2 are disposed at the center in the left-right direction. The pads T1, T2, and T3 and the pads T6, T5, and T4 are each line-symmetrical with respect to the virtual straight line P0 (centered on the virtual straight line P0). The pads M1, R1, and C1 and the pads M2, R2, and C2 are line-symmetrical with respect to the virtual straight line P0. The pads H1 and H3 are line-symmetrical with respect to the virtual straight line P0.

A width of the pad operation portion 50 in the left-right direction is smaller than a shoulder width of the user 101. Therefore, when the user 101 directly faces the input device 100 with the pad K at most front side, a position of the wrist is usually closer to the virtual straight line P0 than positions of elbows of both arms. Therefore, when viewed from above, in a natural performing posture, a forearm (between the elbow and the wrist) is often inclined so that the closer it is to the wrist, the closer it is to the virtual straight line P0.

Therefore, when viewed from above, opposing end surfaces of the pads that are adjacent to each other in the left-right direction are straight lines, and are inclined such that the farther back the end surfaces are, the closer the end surfaces are to the virtual straight line P0. For example, a right end surface 56 of the pad S1 and a left end surface 57 of the pad R2 are parallel and face each other. Further, the right end surface 56 and the left end surface 57 are straight lines when viewed from above, and are inclined such that the farther back the end surfaces are, the closer the end surfaces are to the virtual straight line P0. The opposing end surfaces of the pads that are adjacent to each other in the left-right direction, such as end surfaces 54 and 55, end surfaces 58 and 59, and end surfaces 63 and 64, all have a relationship same as that of the end surfaces 56 and 57. With such a configuration, it is possible to guide a user posture from an elbow to fingertips into a natural shape.

Further, when viewed from above, a boundary line 51 between the first region 10 and the fourth region 40, a boundary line 53 between the second region 20 and the third region 30, and a boundary line 52 between the fourth region 40 and the second region 20 are all curved lines that are convex toward the front side. Due to the inclination of the end surfaces and the curvature of the boundary lines, a performance input in a reasonable natural posture is facilitated. At least one of the boundary lines 51, 52, and 53 may be a curved line.

As shown in FIG. 2, in the left-right direction, a length L1 of the pad K included in the first region 10 to which the bass drum tone is assigned is equal to or longer than a length L3 across two or more pads included in the third region 30. Here, the length L3 is a maximum length of an arrangement region of the pads H1 to H3 in the left-right direction. The length L1 is a minimum length of the pad K in the left-right direction.

Similarly, in the left-right direction. a length L2 of the pad S1 included in the second region 20 to which the first snare drum tone is assigned is also equal to or longer than the length L3. The length L2 is a minimum length of the pad S1 in the left-right direction.

Therefore, the pads K and S1 are horizontally elongated in the left-right direction. In addition, areas of the pads K and S1 are larger than areas of the pads H1 to H3 in the third region 30 to which the cymbal tones are assigned. Therefore, for example, it is easy to repeatedly strike the pads K and S1 using both hands. In addition, even in a performance in which various pads are combined, a natural hand shape is easily maintained. For example, it is easy to strike (tap) not only a combination of the pads K, S1, and H3 but also a combination of the pads K, S1, and H2 or the pads K, S1, and C2. The length L3 to be compared with the lengths L1 and L2 may be the maximum length of an arrangement region of two of the pads H1 to H3. Such length and area conditions may be satisfied by at least one of the pads K and S1.

The pad S1 is provided with a protruding portions 61 and 62 protruding upward. The user can visually recognize the position of the pad S1 by touching either of the protruding portions 61 and 62. From this point of view, instead of the protruding portions 61 and 62, it is sufficient to provide an identification portion that can be recognized by a sense of touch, and may be a recess or a notch, for example. A position of the identification portion and a pad on which the identification portion is provided are not limited to those illustrated.

Since the second region 20 and the third region 30 are adjacent to each other in the front-rear direction, for example, the pads included in the second region 20 and the pads included in the third region 30 are easily operated with an index finger and a middle finger. Focusing on the first region 10, the second region 20, and the third region 30, since the first region 10, the second region 20, and the third region 30 are disposed in this order toward the rear, the first region 10 can be easily operated with a thumb.

FIG. 3 is a diagram showing an example of a pad operation mode. Hereinafter, the description will be made assuming the right-handed user 101 as a representative. An operation of a left-handed user can be understood with left-right symmetry.

When a thumb 71 is positioned on the pad K (first operator) and a middle finger 73 is positioned on the pad H3 (third operator), the pads K, H3, and S1 are disposed such that an index finger 72 is positioned on the pad S1 (second operator). This means that when the right-handed user 101 positions the thumb 71 and the middle finger 73 on the pads K and H3, respectively, with a relaxed, natural hand posture, the index finger 72 will naturally position on the pad S1. This is achieved because the virtual straight line P0 passing through the centroid G10 and the centroid G20 does not pass through the pad H3 when viewed from above.

Here, the kick drum (pad K), the first snare drum (pad S1), and the closed hi-hat cymbal (pad H3) are pads frequently used in combination in a typical 8-beat performance. Since these pads can be used frequently in a state close to a relaxed posture, an input operation of performance information is easy.

When using another expression for the arrangement of the pads K, H3, and S1, when the fingers 71 and 73 are positioned at the centroid G10 of the pad K and the centroid of the pad H3, respectively, it can be said that the finger 72 is positioned at the centroid G20. A mutual interval between the fingers 71, 72, and 73 in the relaxed posture is determined assuming an average-sized human hand.

Further, the pads K and S1 are horizontally elongated. Therefore, in the case of the right-handed user 101, when the hand is slightly shifted to the left and right while maintaining a finger posture shown in FIG. 3, it is easy to strike (tap) not only a combination of the pads K, S1, and H3 but also a combination of the pads K, S1, and H2 or the pads K, S1, and C2.

As shown in FIG. 2, the pad S1 and the pads H1, H2, and H3 are adjacent to one another in the front-rear direction. For example, focusing on the pad S1 and the pad H3, it is considered that a typical 8-beat is performed with the right hand, which is the dominant hand. In order to perform as simply as possible, it is desired to reduce a horizontal movement of the wrist or the finger while keeping a natural hand shape (while keeping an increase or decrease of the interval between the fingers small).

Therefore, the closed hi-hat cymbal (pad H3), which is tapped many times, is suitable for being tapped with the middle finger. This is because the middle finger has stamina and it is easy to use a centrifugal force from the wrist. The first snare drum (pad S1), which is tapped the most times after the closed hi-hat cymbal, is suitable for being tapped with the index finger. This is because the index finger is shorter than the middle finger, making it easier to respond to small changes in movement, making it compatible with the performance characteristics of the snare drum, which often involves high-speed, complex strikes.

The kick drum (pad K), which is tapped the most times after the first snare drum, is suitable for being tapped with the thumb. This is because the thumb is suitable for exerting a stable force rather than a fine movement, and is compatible with the performance characteristics of the kick drum, which often repeats simple patterns.

In this way, by operating the pads K, S1, and H3 with the thumb, the index finger, and the middle finger, respectively, the typical 8-beat performance can be achieved in a comfortable posture.

A set of pads disposed line-symmetrically with respect to the virtual straight line P0 can be easily adapted to both left and right dominant hands, and also facilitates an advanced performance using a combination of opposite dominant hands, such as an alternate performing method. As an example, a set of the pads H1 and H3, to which the closed hi-hat cymbal tone is assigned, are disposed at symmetrical positions on both sides of the pad H2, to which the open hi-hat cymbal tone is assigned. The user alternately strikes the pads H1 and H3 with left and right middle fingers. Therefore, it is possible to easily perform a 16-beat performance using an alternate performing method using the middle fingers. At this time, the thumbs and the index fingers of the left and right hands can be positioned on the same pads (pad K and S1).

An advanced performance that combines the open hi-hat cymbal and the closed hi-hat cymbal is considered. Ideally, the pads are preferably disposed close to each other and in order in the left-right direction. The reasons are as follows. First, a movement in the front-rear direction involves a movement of the elbow, but a small movement in the left-right direction can be easily achieved by moving the wrist without moving the elbow. Moreover, when comparing the wrist and the elbow, the wrist is more suitable for a high-speed movement. This is because, although it is possible to adjust a striking position by adjusting a degree to which the fingers are spread, it is difficult to maintain a state in which the fingers are extremely open or closed for a long time in a relaxed manner.

Taking the above into consideration, the pads H1 and H3 are disposed close to the pad H2 and on both left and right sides of the pad H2. Therefore, it is easy to employ an alternate performing method on the pads H1 and H3 using the left and right middle fingers, while striking the pad H2 with either the left or right middle fingers.

Next, distinguished tapping of the two snare drums will be described. Ideally, as a snare drum, three pads are desired in order for distinguished tapping of a normal open shot, an open rim shot, and a closed rim shot. However, there is a space restriction. It is considered that if there are two types of pads, that is, the pad S1 that is frequently tapped and the pad S2 that is less frequently used, it is possible to substantially cope with a realistic use case. Therefore, the pads S1 and S2 are disposed adjacent to each other in the front-rear direction, and the pad S2 is disposed in front of the pad S1. Similarly to the pad S1, the pad S2 is also assumed to be struck with the index finger. Since the position of the index finger in the front-rear direction can be easily adjusted by keeping the finger apart within a reasonable range relative to the thumb, it is possible to strike the pad S2, which is less frequently used, relatively easily.

Focusing on the pads C1 and C2 as a set disposed line-symmetrically with respect to the virtual straight line P0, a performing method that combines crash cymbals is considered. In general, in many cases, hi-hat cymbals in a beat are replaced with crash cymbals. Therefore, the pads C1 and C2 are disposed close to the pads H1 and H3, respectively, and in order in the left-right direction with respect to the pads H1 and H3, respectively. That is, the pad C1 is disposed on the left side of the pad H1, and the pad C2 is disposed on the right side of the pad H3. Since the wrist can move horizontally at a high speed, it is assumed that the pads C1 and C2 are struck with the middle finger.

Different crash cymbal tones are assigned to the pads C1 and C2. This is because there are few cases where the same crash cymbal tone is struck repeatedly with both hands (alternate performing method). Different ride cymbal tones may be assigned to the pads C1 and C2.

Next, it is considered that the crash cymbal is tapped simultaneously with the kick drum or the snare drum. The crash cymbal is rarely tapped alone. The pads K and S1 are horizontally elongated, and pad surfaces of each are continuous without boundaries, and the tone generated is the same no matter where the pad is struck. The pad S2 is also relatively horizontally elongated. As described above, when the hand moves to the left and right while maintaining the finger posture shown in FIG. 3, the strike can be performed in a combination of the pads K, S1, and C2. At this time, a natural hand shape is maintained and no excessive force is required.

Next, a performing method that replaces the hi-hat cymbal with the ride cymbal is considered. The hi-hat cymbal in the beat is often replaced by the crash cymbal. Therefore, it is desirable that the ride cymbal be positioned close to the crash cymbal. Therefore, the pads R1 and R2 are disposed in front and adjacent to the pads C1 and C2. It is assumed that the pads R1 and R2 are struck with the middle finger. With such an arrangement, it is easy to tap the pads R1 and R2 with the middle finger while keeping the thumb and index finger positioned on the pads K and S1, respectively. In this case, a natural hand shape is likely to be maintained, especially in the relationship between the thumb and index finger.

As described above, different ride cymbal tones are assigned to the pads R1 and R2. This is because while there are few cases in which two or more ride cymbals are used, there are many cases in which one ride cymbal is used to switch back and forth between the RideCup and the RideTip. Moreover, since there are few cases in which the RideCup or the RideTip is struck repeatedly using both hands, it is less necessary to symmetrically arrange the same tone.

Next, continuous striking of tom drums is considered. In the fourth region 40, as sets that are line-symmetrical with respect to the virtual straight line P0, there are a set of the pad T3 and the pad T4, a set of the pad T2 and the pad T5, and a set of the pad T1 and the pad T6. The plurality of symmetrical sets are disposed in order on both sides of the pad S2 disposed in the center. With such an arrangement, it is easy to repeatedly strike the tom drums while switching fingers, regardless of the dominant hand.

First, there are many cases where the snare drum and the tom drums are switched back and forth. In addition, there are cases where the tom drums are more important than the second snare drum. Therefore, an area of the second snare drum (pad S2) is made smaller than that of the pad S1, and the pads T3 and T4 are disposed close to the pad S2. There are many cases where the pads are tapped in the order of snare drum, high tom drums, low tom drum, and floor tom drum. In addition, it is not only easy to move the hand in the left-right direction, but also it is possible to perform a continuous movement by simply changing the fingers.

Therefore, by disposing the pads T4, T5, and T6 in order toward the right, it is easy to perform by striking the pad T4 with the index finger of the right hand, the pad T5 with the middle finger, and the pad T6 with the ring finger. Regarding the left hand, by disposing the pads T3, T2, and T1 in order toward the left, it is easy to perform by striking the pad T3 with the index finger of the left hand, the pad T2 with the middle finger, and the pad T1 with the ring finger. In this way, it is easy to continuously generate different tom drum tones with either hand by changing the fingers. The number of types of tom drum tones is not limited.

The pads M1 and M2 are disposed at left front and right front positions. Since there are many restrictions on performance operations at these positions, it is desirable to dispose pads that are less frequently used. An empty space after laying out important pads is effectively used.

In addition, a top surface of the panel 103 may have an inclination such that the front side is lower. Accordingly, a height of an upper end of each pad from an installation surface may be lower as the pad is disposed closer to the front side. With such a configuration, it is easy to operate all the pads. For example, the upper surface of the panel 103 is close to a flat surface when viewed from naturally held fingers. When held naturally, the thumb extends downward.

According to the embodiment, each of the first region 10, the second region 20, and the third region 30 includes one or more pads to which the bass drum tone, the snare drum tone, and the cymbal tone are assigned. The second region 20 and the third region 30 are sequentially disposed in a direction away from the first region 10, and the shapes of the first, second, and third regions are different from one another. Therefore, it is possible to facilitate an input operation of performance information. In particular, when the thumb 71 is positioned on the pad K and the middle finger 73 is positioned on any of the pads H1 to H3, the index finger 72 is positioned on the pad S1. Therefore, a high frequency performance such as an 8-beat can be performed in a state close to a relaxed posture.

The second region 20 and the third region 30 are adjacent to each other in the front-rear direction. For example, the pad S1 and the pads H1 to H3 are adjacent to one another. Therefore, the pads in the second region 20 and the pads in the third region 30 can be easily operated with the index finger and middle finger.

The length L1 of the pad K and the length L2 of the pad S1 are both equal to or longer than the length L3 across the pads H1 to H3 in the left-right direction. Moreover, the areas of pads K and S1 are larger than the areas of any of pads H1 to H3. Therefore, it is easy to repeatedly strike the pads K and S1 using both hands. In addition, even in a performance in which various pads are combined, a natural hand shape is easily maintained.

In addition, since all of the boundary lines 51, 53, and 52 are curved lines that are convex toward the front side, a performance input in a reasonable natural posture is facilitated.

At least one set of pads in each of at least one region of the first, second, and third regions are disposed line-symmetrically with respect to the virtual straight line P0. For example, the pads H1 and H3 are disposed at symmetrical positions on both sides of the pad H2. Therefore, the pads can be adapted to both dominant hands, and it is easy to perform an alternate performing method such as closed hi-hat cymbals.

Since the set of the pads C1 and C2 are disposed at symmetrical positions adjacent to the pads H1 and H3, respectively, it is possible to reduce an amount of movement of the finger moving back and forth between the pads H1 and H3 and the pads C1 and C2.

A plurality of sets of pads T3 and T4, T2 and T5, and T1 and T6, which are included in the fourth region 40 and to which the tom drum tone is assigned, are disposed line-symmetrically with respect to the virtual straight line P0, and are disposed in order on both sides of the pad S2. Therefore, it is easy to repeatedly strike the tom drums while switching fingers, regardless of the dominant hand.

In addition, since the pad S1 is provided with the protruding portions 61 and 62, the position of the pad S1 can be recognized without visual recognition.

It is not essential to provide the fourth region 40. For example, the first region 10 and the second region 20 may be adjacent to each other. The arrangement position of the fourth region 40 is not limited. For example, the fourth region 40 may be disposed between the second region 20 and the third region 30, or may be disposed in front of the first region 10 or behind the third region 30.

The input device 100 does not necessarily have to be implemented as an electronic musical instrument, and does not necessarily have a sound generation function. Therefore, it is not essential to provide the speaker 97. For example, an output terminal may be provided in the input device 100, and sound information corresponding to an input operation may be output from the output terminal to the outside. For example, a sound generation device (not shown) may be connected to the output terminal, and a sound may be generated from the sound generation device. The input device 100 may be used to input performance information to be recorded by recording the input performance information in a memory (not shown) or outputting the input performance information to the outside. The input performance information may be reproduced or recorded in another device.

The input device 100 may be mounted on another electronic device such as an electronic musical instrument (portable keyboard or the like) or a MIDI keyboard.

The pad is not limited to a physical pad, and a pad arrangement may be implemented on a screen such as a tablet.

A modification shown in FIG. 4 may be employed. FIG. 4 is an enlarged view of a plurality of pads in the pad operation portion 50 according to the modification. In the example shown in FIG. 2, the boundary line 51 between the first region 10 and the fourth region 40, the boundary line 53 between the second region 20 and the third region 30, and the boundary line 52 between the fourth region 40 and the second region 20 are all curved lines that are convex toward the front side. However, this is not essential, and all of the boundary lines 51, 53, and 52 may be straight lines parallel to the left-right direction. In FIG. 4, the configuration same as that of FIG. 2 can be employed for the relative arrangement and the symmetrical relationship of the respective pads.

Although the present disclosure has been described in detail based on a preferred embodiment thereof, the present disclosure is not limited to the specific embodiment, and various forms without departing from the scope of the present disclosure are also included in the present disclosure.

1. An input device comprising:
a first region including one or more operators to which a bass drum tone is assigned;
a second region including one or more operators to which a snare drum tone is assigned; and
a third region including one or more operators to which a cymbal tone is assigned, wherein:
the second region and the third region are arranged in order in a direction away from the first region, and
a shape of the first region, a shape of the second region, and a shape of the third region are different from one another.

2. The input device according to claim 1, wherein the second region and the third region are adjacent to each other in an arrangement direction in which the first region, the second region, and the third region are arranged.

3. The input device according to claim 1, wherein:
the third region includes a plurality of operators, and
one of the one or more operators to which the bass drum tone is assigned in the first region has a length equal to or longer than a length across two or more operators included in the third region in a direction perpendicular to an arrangement direction in which the first region, the second region, and the third region are arranged.

4. The input device according to claim 3, wherein at least one of an area of the one of the one or more operators to which the bass drum tone is assigned in the first region or an area of one of the one or more operators to which the snare drum tone is assigned in the second region is larger than an area of any of the one or more operators in the third region to which the cymbal tone is assigned.

5. The input device according to claim 1, wherein:
the third region includes a plurality of operators, and
one of the one or more operators to which the snare drum tone is assigned in the second region has a length equal to or longer than a length across two or more operators included in the third region in a direction perpendicular to an arrangement direction in which the first region, the second region, and the third region are arranged.

6. The input device according to claim 5, wherein at least one of an area of one of the one or more operators to which the bass drum tone is assigned in the first region or an area of the one of the one or more operators to which the snare drum tone is assigned in the second region is larger than an area of any of the one or more operators in the third region to which the cymbal tone is assigned.

7. The input device according to claim 1, wherein at least one of a boundary line between the first region and another region or a boundary line between the second region and the third region is a curved line.

8. The input device according to claim 1, wherein the one or more operators to which the snare drum tone is assigned in the second region and the one or more operators to which the cymbal tone is assigned in the third region are adjacent to each other in an arrangement direction in which the first region, the second region, and the third region are arranged.

9. The input device according to claim 1, wherein:
operators in each of at least one of the first region, the second region, or the third region are classified into at least one set of operators, and
the operators in each of the at least one set are disposed line-symmetrically with respect to a virtual straight line which is parallel to an arrangement direction in which the first region, the second region, and the third region are arranged.

10. The input device according to claim 1, wherein:
the one or more operators in the third region include an operator to which an open hi-hat cymbal tone is assigned and a first set of operators to which a closed hi-hat cymbal tone is assigned, and
the operators in the first set are disposed at symmetrical positions on both sides of the operator to which the open hi-hat cymbal tone is assigned.

11. The input device according to claim 10, wherein:
the one or more operators in the third region further include a second set of operators to which a crash cymbal tone or a ride cymbal tone is assigned, and
the operators in the second set are disposed at symmetrical positions adjacent to respective operators in the first set.

12. The input device according to claim 1, further comprising:
a fourth region between the first region and the third region in an arrangement direction in which the first region, the second region, and the third region are arranged,
wherein the fourth region includes one or more operators to which a tom drum tone is assigned.

13. The input device according to claim 12, wherein:
the fourth region includes a center operator disposed at a center in a direction perpendicular to the arrangement direction and a plurality of sets of operators into which the one or more operators to which the tom drum tone is assigned are classified,
the operators in each of the plurality of sets are disposed line-symmetrically with respect to a virtual straight line parallel to the arrangement direction, and
the plurality of sets are disposed in order on both sides of the center operator.

14. The input device according to claim 1, wherein in the second region, at least one of the one or more operators to which the snare drum tone is assigned is provided with an identification portion that is allowed to be recognized by a sense of touch.

15. An input device comprising:
a first operator to which a bass drum tone is assigned;
a second operator to which a snare drum tone is assigned; and
a third operator to which a cymbal tone is assigned,
wherein the first operator, the second operator, and the third operator are disposed such that when a thumb is positioned on the first operator and a middle finger is positioned on the third operator, an index finger is positioned on the second operator.

16. The input device according to claim 15, wherein a virtual straight line passing through a centroid of the first operator and a centroid of the second operator does not pass through the third operator when viewed from above.
